(19) United States
(12) Patent Application Publication
(10) Pub. No.: US 2014/0016530 A1
(43) Pub. Date: Jan. 16, 2014

(54) DELIVERY SERVER, AND TERMINAL DEVICE

(71) Applicant: Mitsubishi Electric Corporation, Chiyoda-ku (JP)

(72) Inventor: Hiroaki HIRAI, Tokyo (JP)

(21) Appl. No.: 13/933,432

(22) Filed: Jul. 2, 2013

(30) Foreign Application Priority Data
Jul. 10, 2012 (JP) 2012-154983

(51) Int. Cl. H04W 4/06

(52) U.S. Cl. CPC H04W 4/06
USPC 370/312

(57) ABSTRACT

A content delivery system which comprises a delivery server and multiple terminal devices, the delivery server delivering content, the multiple terminal devices receiving delivery of the content, in the content delivery system connection between the delivery server and the terminal devices and connection between the terminal devices being made by radio, in the content delivery system the terminal devices being connected in multiple stages, wherein the delivery server instructs a terminal device which has received delivery of the content and which is connected to an other terminal device at the next stage to deliver content possessed by a self terminal device to the other terminal device, and wherein the instructed terminal device delivers content possessed by the self terminal device to the other terminal device and notifies the delivery result to the delivery server.

### BACKGROUND OF THE INVENTION

1. Field of the Invention

The present invention relates to a content delivery system that delivers content.

2. Description of the Related Art

Conventionally, techniques such as signboards, posters, bulletin boards, showcases, and the distribution of handbills or pamphlets have been used as methods of displaying information to the general public. However, where substances such as printed literature or exhibits are involved, it has been difficult to achieve a change to content in a short time. In order to solve this problem, it has been proposed to change signboards, posters, or bulletin boards throughout town for display apparatuses to display according to the advertisement technique used in broadcasting, and in these years a market which is collectively referred to by the term “digital signage” is beginning to be formed. By means of the digital signage, information display can be effectively performed in the form of a product advertisement, a notice, a news report, information delivery, publicity, or so on in commercial facilities, downtown, public institutions, or so on, where many and unspecified people are expected to come and go.

As to the way to update content, while with some products, content is rewritten manually with use of a USB memory or an SD card, products which can deal with delivery via a network for the purpose of labor saving and instant updating are coming out. Further, products have come out which utilize radio such as WiMAX or WLAN in order to reduce the cost of laying network lines or relocating a network when changing layout (Non Patent Literature 1: Digital Signage White Paper 2011 by Digital Signage Consortium, Jun. 8, 2011, First Edition). Meanwhile, as to the radio technology, as a technology for extending communication distance to improve usability, multi-hop communication technology wherein terminals themselves perform relay, represented by ZigBee (registered trademark) or the like, has been being put into practical use.

For example, where digital signage terminals are installed in sales space in retail stores to perform advertisement, in order to use WLAN technology wherein terminals directly connect to a content delivery server that is an access point, digital signage terminals need to be installed within the communication range of the content delivery server. Accordingly, by combining it with the multi-hop communication technology, installation in places where direct connection cannot be made is enabled, and merits such as communication continuation due to path redundancy or the like can be enjoyed. By using this connection configuration to deliver content and schedule to be displayed to each digital signage terminal, the simplification of installation can be achieved.

### SUMMARY OF THE INVENTION

However, according to the aforementioned conventional art, the content delivery server needs to deliver to digital signage terminals one by one sequentially. Hence, there is the problem that even without overhead such as a re-connection process due to radio communication disconnection at all, it takes a long delivery time to deliver a large amount of content. For example, if the method that delivers content after store hours is used, power supply cannot be turned off for that period, thus hindering saving energy and also taking personnel costs wastefully.

The present invention was made in view of the above facts, and an object thereof is to provide a content delivery system which can deliver content highly efficiently to a large number of digital signage terminals.

There is provided a content delivery system which comprises a delivery server and multiple terminal devices, the delivery server delivering content, the multiple terminal devices receiving delivery of the content, in the content delivery system connection between the delivery server and the terminal devices and connection between the terminal devices being made by radio, in the content delivery system the terminal devices being connected in multiple stages, wherein the delivery server instructs a terminal device which has received delivery of the content and which is connected to an other terminal device at the next stage to deliver content possessed by a self terminal device to the other terminal device, and wherein the instructed terminal device delivers content possessed by the self terminal device to the other terminal device and notifies the delivery result to the delivery server.

### BRIEF DESCRIPTION OF THE DRAWINGS

FIG. 1 is a diagram showing a digital signage system which is a combination of WLAN technology with multi-hop communication technology.

FIG. 2 is a diagram showing the way to deliver content to each digital signage terminal.

FIG. 3 is a diagram showing communication paths in the content delivery system according to Embodiment 1.

FIG. 4 is a diagram showing delivery operation in normal case according to Embodiment 1.

FIG. 5 is a diagram showing delivery operation in a case of a link failure according to Embodiment 1.

FIG. 6 is a sequence diagram showing relay delivery operation according to Embodiment 1.

FIG. 7 is a diagram showing communication paths in the content delivery system according to Embodiment 2.

FIG. 8 is a diagram showing delivery operation in normal case according to Embodiment 2.

FIG. 9 is a diagram showing delivery operation in a case of a link failure according to Embodiment 2.

FIG. 10 is a sequence diagram showing relay delivery operation according to Embodiment 2.

### DETAILED DESCRIPTION OF THE PREFERRED EMBODIMENTS

Embodiments of the content delivery system according to the present invention will be described in detail below with reference to the drawings. Note that the embodiments are not intended to limit the present invention.

### Embodiment 1

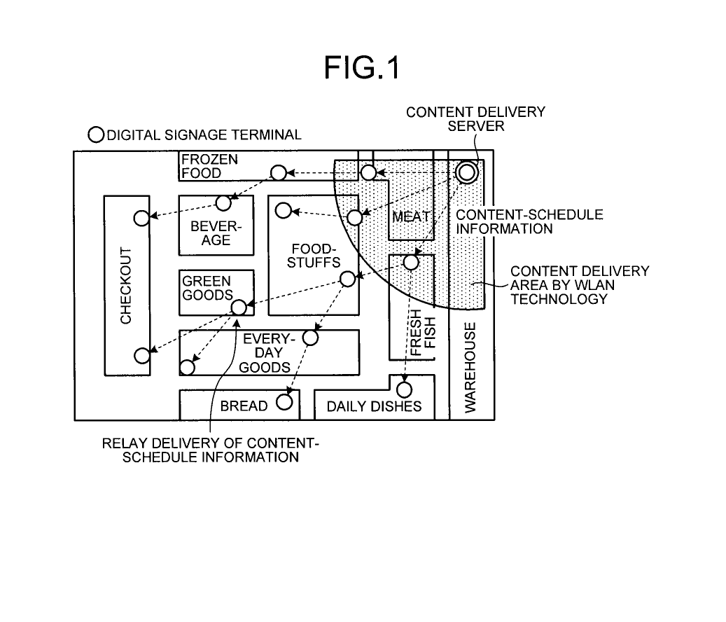

First, a digital signage system which is a combination of conventional WLAN technology with multi-hop communication technology will be described briefly. FIG. 1 is a diagram showing a digital signage system which is a combination of WLAN technology with multi-hop communication technology. FIG. 1 is an image where digital signage terminals are installed in sales space in a retail store to perform advertisement, and shows that where digital signage terminals use WLAN technology, wherein terminals directly connect to an access point (a content delivery server in FIG. 1), digital signage terminals need to be installed within a fan-shaped range. By combining with multi-hop communication technology, installation in places where direct connection cannot be made is enabled, and merits such as communication continuation due to path redundancy or the like can be enjoyed. By using this connection configuration to deliver content and schedule to be displayed to each digital signage terminal, the simplification of installation can be achieved.

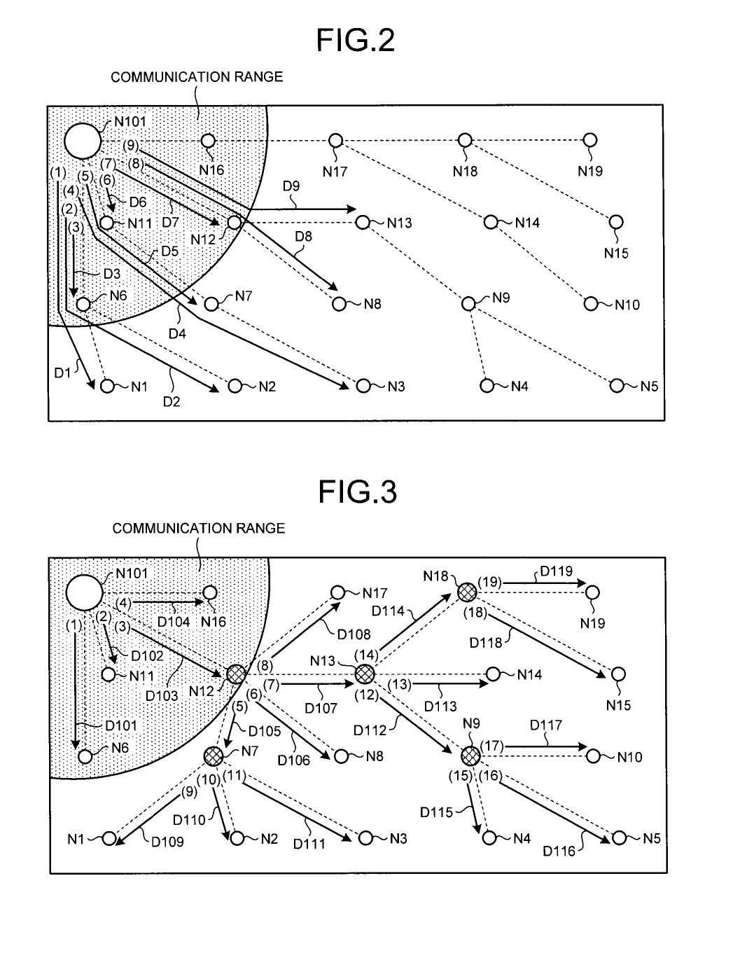

FIG. 2 is a diagram showing the way to deliver content to each digital signage terminal. A system is formed of a delivery server (hereinafter called a server) N101 to deliver content and schedule and digital signage terminals (hereinafter called terminals) N1 to N19 that are terminal devices to receive delivery. In FIG. 2, dotted lines indicate relations of connection by radio, and FIG. 2 shows, for example, that communication between the server N101 and the terminal N1 goes through the terminal N6.

Here, assuming conditions that the link speed of each radio communication is evenly at 5 Mbps and that the same content of 100 Mbytes in size is transmitted to each terminal, the delivery time will be calculated. With the conventional technology, if delivery is performed for the terminals N1 to N19 one by one sequentially through communication paths as indicated by D1 to D9, which go halfway in the figure, it takes a delivery time of about 2 hours and 8 minutes as shown by the following equation (1) to finish delivering data to 19 terminals even without overhead such as a re-connection process due to radio communication disconnection at all.

48 (links)×100 (Mbytes)×8 (bits)÷5 (Mbps)÷3,600 (sec)≈2.133 (hours)≈2 hours and 8 minutes (1)

While there is a case where some contents are displayed only at a particular terminal depending on the type of the content, there is another case where the same content such as an advertisement of the retail store itself is displayed at multiple terminals. In a case where the time required for delivery is long as shown by the above equation (1), that is, where communication efficiency is low, for example, if the method that delivers content after store hours is used, power supply cannot be turned off for that period, thus hindering saving energy and taking personnel costs wastefully.

Further, with radio multi-hop communication, another problem caused by the low efficiency concerns path construction and maintenance. In the subject system, when a large amount of content, e.g., content of 100 Mbytes in size as assumed above is delivered, and 1,000 bytes are sent in one radio frame, the number of frames is calculated to be 100,000 from the equation (2) below. It is supposed that during the communication time required for as many as 100,000 frames, radio communication characteristics vary with each link due to fading or the like or that an obstacle gets in between terminals.

100 (Mbytes)÷1,000 (bytes/frame)=100,000 (frames) (2)

In this case, the tasks are that the communication path needs to be reconstructed and that for a new path, with transmitted data being managed, communication needs to be continued from halfway.

Next, a system that highly efficiently delivers and relays content according to the present embodiment will be described. FIG. 3 is a diagram showing communication paths in the content delivery system according to the present embodiment. The reference numerals and arrangement of the server N101 and the terminals N1 to N19 are the same as in FIG. 2 for making comparison with the conventional art easier.

The server N101 to deliver content and schedule has a means that delivers content and schedule information, and a function that manages the presence of the terminals N1 to N19 to deliver to and information on paths through radio sections according to a routing protocol in advance of information delivery of content and schedule. Note that the type of the routing protocol does not matter.

The terminals N1 to N19 have a storage that stores content and schedule information, a mechanism and a function to respectively reproduce and display content according to the schedule information, a means that receives content and schedule by radio communication, and a function that relay-redelivers content and schedule information held in the storage in response to the reception of an instruction to relay.

The server N101 performs delivery through communication paths D101, D102, D103, and D104 for the terminals N6, N11, N12, and N16 with which it can directly communicate. Then, the server N101 instructs the terminal N12 to deliver to the terminals N7, N8, N13, N17 which can be communicated via the terminal N12 through the communication paths D105, D106, D107, D108 and performs delivery confirmation. The terminal N12 delivers content and schedule stored in itself, but the server N101 performs control associated with the communication as in a conventional delivery mechanism. Thus, the server N101 can perform management to realize the terminals to which delivery has finished and to realize progress, if halfway through delivery, as in the conventional art.

Next, the operation of delivery and relay of content and the like in the content delivery system according to the present embodiment will be described. The server N101 determines the order in which to deliver, for example, to deliver in the order of terminals N6, N11, N12, N16, N7, N8, . . . , N15, N19 (the order indicated by numbers in open circles) as shown in FIG. 3. The delivery order is an ascending order of from an adjacent one with a smallest number of hops, and in the case of the same number of hops, the terminal N7 may transmit to the terminals N1 to N3 at one time, or the delivery order may be such a mixed order that, e.g., after the terminal N7 transmits to the terminal N1, the terminal N13 transmits to the terminal N18.

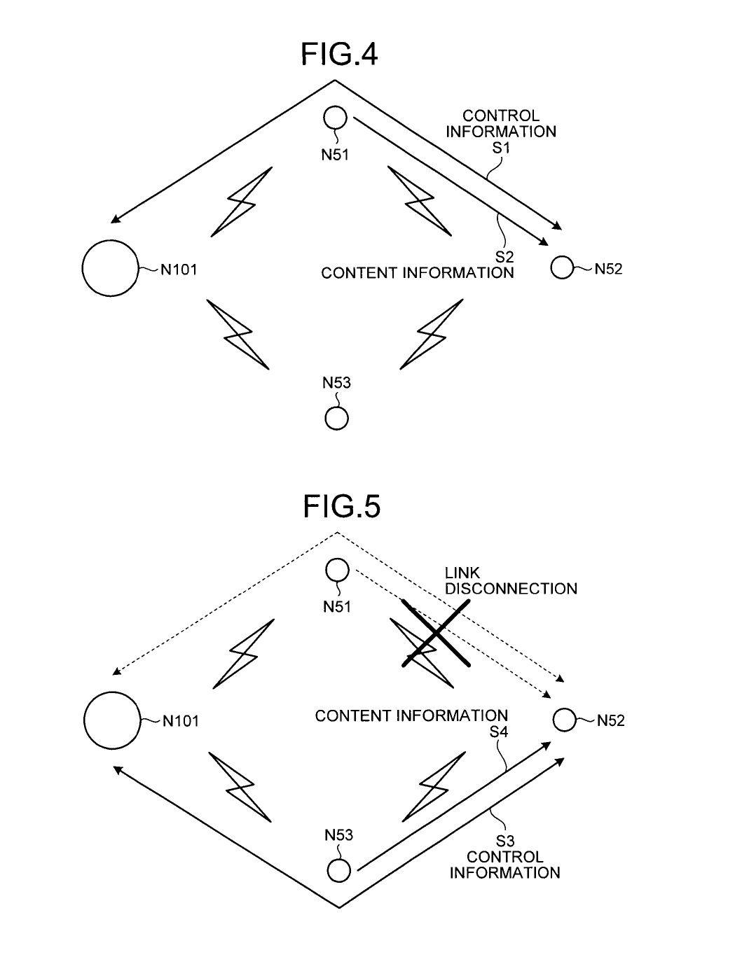

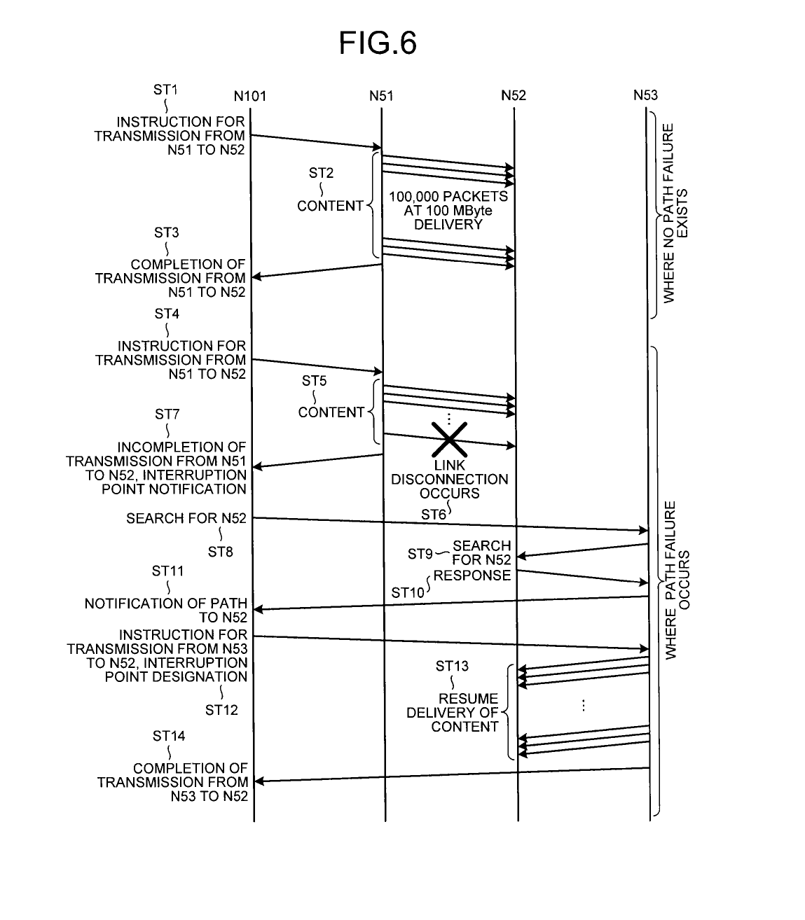

Here, the operation in the case where a link failure occurs during relay delivery because radio communication characteristics vary with each link due to fading or the like, or an obstacle gets in between terminals, or so on will be described using FIGS. 4 to 6. FIG. 4 is a diagram showing delivery operation in normal case according to the present embodiment. FIG. 5 is a diagram showing delivery operation in the case of a link failure according to the present embodiment. FIG. 6 is a sequence diagram showing relay delivery operation according to the present embodiment.

In FIG. 4, description will be made letting the server N101 represent what serves as a server delivering content and schedule as above and using three terminals N51, N52, N53 as digital signage terminals. The positional relation is that the server N101 directly connects to the terminals N51, N53 by radio and can connect to the terminal N52 via the terminal N51 or N53.

Further, in FIG. 4, control information S1 represents the contents of content information for the server N101 to deliver to the terminal N52, an instruction to transmit, delivery confirmation, and a response. Content information S2 represents specific information to be delivered to the terminal N52 out of content and schedule information held in the storage of the terminal N51.

After finishing direct delivery of content and schedule to the terminals N51, N53, the server N101 instructs the terminal N51 to deliver content and schedule stored in the terminal N51 to the terminal N52. This operation is shown in the upper part of FIG. 6 that is the case where no path failure exists. Note that the arrows in FIG. 6 indicate a direction meaningful as information and that delivery confirmation in radio sections is omitted from the figure.

First, the server N101 issues to the terminal N51 an instruction that specifies the contents to be transmitted (step ST1). The instruction that specifies the contents to be transmitted may include a file name designation, frame numbers for dividing and managing content, and, e.g., a hash value obtained through a hash function to make management information be of a particular fixed length. The control information and the content information may be common across the system or encrypted on a per link basis.

The terminal N51 relay-redelivers content and schedule information held in the storage (only the content is shown in FIG. 6; hereinafter the same is true) to the terminal N52 according to the transmission instruction (step ST2). Then, the terminal N51 returns to the server N101 the result of delivery to the terminal N52 (here transmission completion) (step ST3). By this means, the server N101 can manage the delivery status of the terminal N52.

Next, the case where an interruption (a path failure) occurs during relay redelivery from the terminal N51 to the terminal N52 is shown in FIG. 5 and the lower part of FIG. 6. The server N101 instructs the terminal N51 to transmit (step ST4). While the terminal N51 is relay-redelivering content and schedule information held in its storage to the terminal N52 according to the transmission instruction (step ST5), a link disconnection occurs between the terminal N51 and the terminal N52 (step ST6). The terminal N51 returns to the server N101 a transmission incompletion notification and an interruption point notification instead

Docket No. PMDA-13041-US of a transmission completion notification (step ST7). The interruption point designation in the interruption point notification may include a completely transmitted file name and an incompletely transmitted file name, frame numbers, a pointer position in the total size, or the like, by which the interruption point is identifiable.

In FIG. 5, control information S3 represents new-path information, the contents of content information for the terminal N53 to deliver to the terminal N52 and a transmission instruction, delivery confirmation, and a response. Content information S4 is specific information to be delivered to the terminal N52 out of content and schedule information held in the storage of the terminal N53.

The server N101 searches for the terminal N52 based on the incompletion notification (step ST8). FIGS. 5 and 6 show the case where the terminal N53 responds that it can relay. In this case, the terminal N53 searches for the terminal N52 (step ST9); the terminal N52 gives a response to the terminal N53 (step ST10); and the terminal N53 notifies the server N101 of a path to the terminal N52 (step ST11).

The server N101 notifies the terminal N53 of an instruction to deliver content subsequent to the interruption location, which the terminal N52 does not possess (step ST12). The terminal N53 relay-delivers missing content to the terminal N52 (step ST13), and when completed, notifies the server N101 of transmission completion (step ST14). In the above, after a link disconnection occurs between terminals, the server N101 searches for an alternative path, but the present invention is not limited to this. If an alternative path is known beforehand, the server N101 may try to communicate over the alternative path to see whether it is possible.

Although with FIGS. 4 to 6 description has been made with the server N101 as a nucleus, the terminal N12 relay-delivering and the terminals N7, N13 and so on relaying in FIG. 3 operate likewise. For example, the terminal N12 delivers according to a transmission instruction from the server N101, and if delivery is interrupted, returns the delivery result to the server N101. Then, the server N101 searches for a new path, and a terminal instructed to relay-deliver over the new path, delivers the missing content out of content and schedule information held in its own storage for completion.

Here, when comparing the numbers of links involved in content delivery in the content delivery systems according to the conventional art and according to the present embodiment, there are 48 links for the conventional art (FIG. 2), whereas the number of links is reduced to 19 links by omitting redundant paths for the present embodiment (FIG. 3). Thus, as shown in the following equation (3), the delivery time can be reduced to about 51 minutes (about two fifths of that of the conventional art), which can be expected to lead to energy saving as well as efficient use of radio resources.

19 (links)×100 (Mbytes)×8 (bits)÷5 (Mbps)÷3,600 (sec)≈0.8444 (hour)≈51 minutes (3)

As described above, according to the present embodiment, in the content delivery system which performs a push type of multi-hop communication by radio, a digital signage terminal which has received content and the like delivered from the delivery server, relay-delivers content and the like held in itself to digital signage terminals at the next stage. The digital signage terminal which has relay-delivered notifies the delivery server of the delivery result, and thus the delivery server can realize the delivery status of each digital signage terminal. Hence, if relay delivery of content and the like is uncompleted due to the occurrence of a link disconnection during relay delivery between digital signage terminals, or so on, the delivery server instructs another digital signage terminal on an alternative path to relay-deliver anew. By this means, redundant links involved in content delivery can be reduced in number, thus realizing high efficient delivery. Further, taking into account overhead that occurs when a communication path is reconstructed because of the influence of radio communication characteristics of an individual link, by arranging for redundancy in delivery not to occur even in this case, high efficient delivery can be realized.

### Embodiment 2

In this embodiment, a server and terminals perform multicasting delivery. The differences from Embodiment 1 will be described.

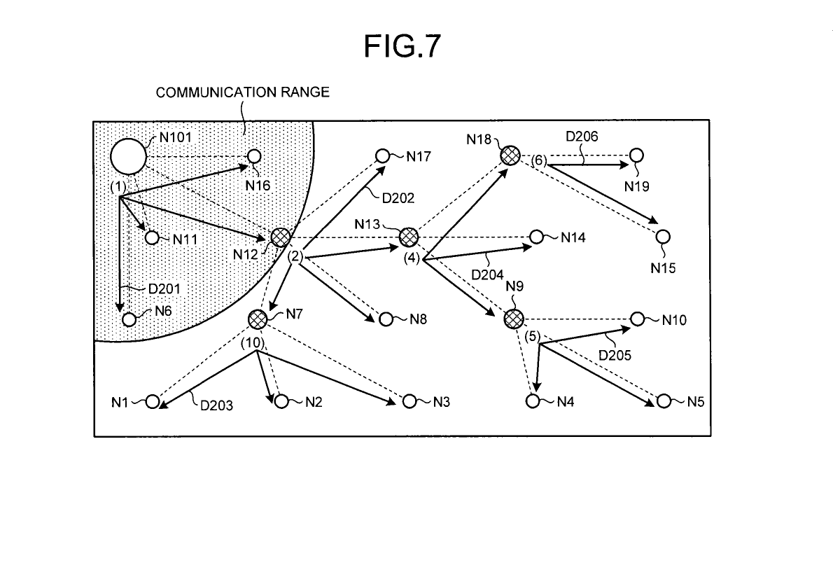

FIG. 7 is a diagram showing communication paths in the content delivery system according to the present embodiment. A server N101 and terminals N1 to N19 have a transmit-receive function for multicasting communication. The type of multicasting communication may be communication simply using multicast addresses or communication wherein error correction by which the reception side can correct a frame error from multiple frames is carried out.

In the present embodiment, the server N101 and terminals N1 to N19 use multicasting delivery for a range where they can simultaneously transmit and receive by radio communication. At the time of multicasting delivery, the server N101 and terminals N1 to N19 set communication speed to match a terminal whose environment is the worst in order to select a common communication speed, and combine an error correction function for correcting bit errors in frames and an over-multi-frame error correction function which can correct even if frame loss occurs, and so on. Note that the server N101 performs control related to communication as in Embodiment 1.

Next, the operation of delivery and relay of content and the like in the content delivery system according to the present embodiment will be described. The server N101 performs a first delivery to the terminals N6, N11, N12, N16 by multicasting communication as shown in FIG. 7. After the completion of the first delivery from the server N101, the terminal N12 performs delivery to the terminals N7, N8, N13, N17 by multicasting communication. Then, the server N101 determines the order in which to deliver, for example, such an order that, e.g., the terminal N7 performs delivery to the terminals N1, N2, N3 by multicasting communication, that the terminal N13 performs delivery to the terminals N9, N14, N18 by multicasting communication, and that finally the terminal N18 performs delivery to the terminals N15, N19 by multicasting communication. The order in which to deliver is an ascending order of from an adjacent one with a smallest number of hops.

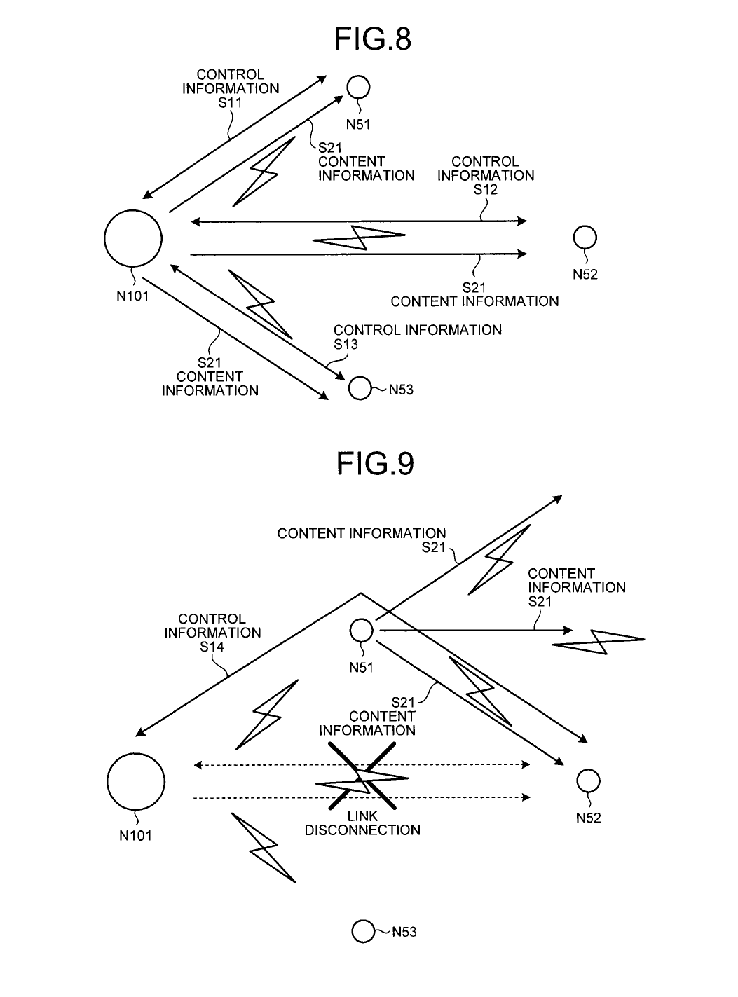

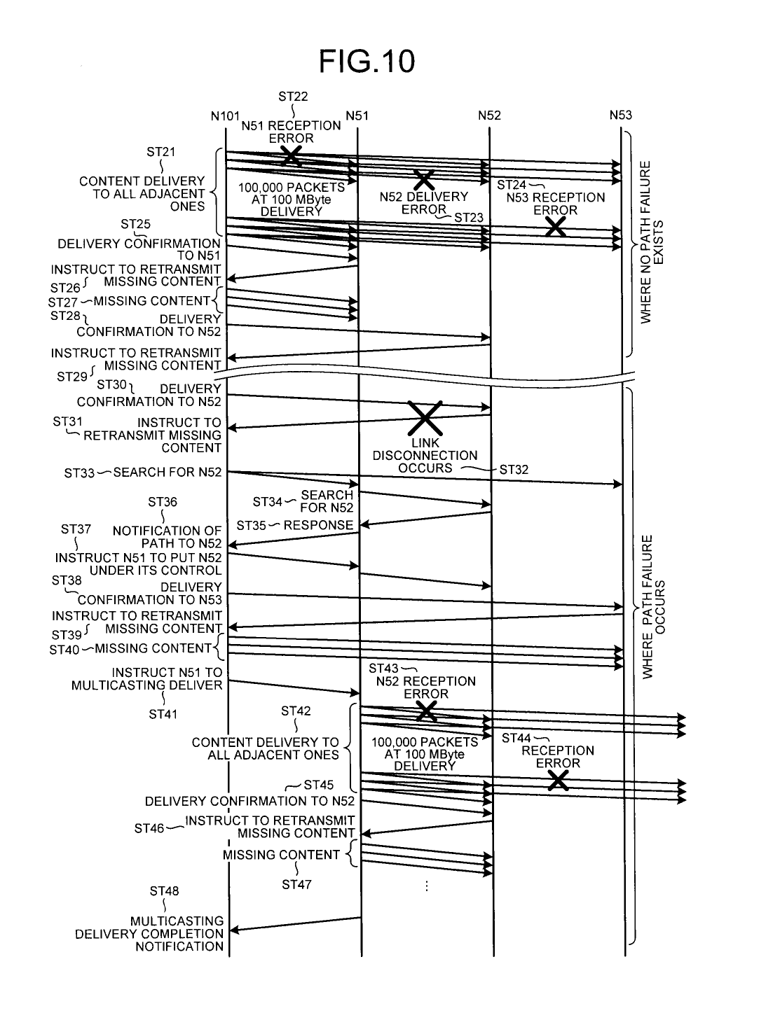

Here, the operation in the case where a link failure occurs during relay delivery because radio communication characteristics vary with each link due to fading or the like or an obstacle gets in between terminals will be described using FIGS. 8 to 10. FIG. 8 is a diagram showing delivery operation in normal case according to the present embodiment. FIG. 9 is a diagram showing delivery operation in the case of a link failure according to the present embodiment. FIG. 10 is a sequence diagram showing relay delivery operation according to the present embodiment.

In FIG. 8, description will be made, letting the server N101 represent as a server delivering content and schedule as above, and using three terminals N51, N52, N53 as digital signage terminals. The present embodiment differs from Embodiment 1 in that they each can multicasting-communicate. The positional relation is that the server N101 directly connects to the terminals N51, N52, N53 by radio and can connect to the terminal N52 via the terminal N51 as well.

Further, in FIG. 8, control information S11 to S13 represent the contents of content information for the server N101 to deliver to the terminals N51 to N53 respectively, delivery confirmation, and retransmission control of missing frames. Content information S21 represents information to be delivered by multicasting delivery out of content and schedule information held in the storage of the server N101.

The operation in the case where no path failure exists is shown in the upper part of FIG. 10. Note that the arrows in FIG. 10 indicate a direction meaningful as information and that delivery confirmation in unicast communication in radio sections is omitted from the figure.

First, the server N101 multicasting-delivers content and schedule information (only the content is shown in FIG. 10; hereinafter the same is true) directly to the terminals N51, N52, N53 (step ST21). Because the communication environment differs, the incorrect frame is different between the terminals N51, N52, N53 (steps ST22, ST23, ST24). After the completion of content delivery to all the adjacent terminals, the server N101 performs delivery confirmation sequentially on the terminals N51, N52, N53. If missing frames exist, the server N101 performs retransmission individually to them, thereby completing delivery to all the adjacent terminals.

Specifically, the server N101 performs delivery confirmation on the terminal N51 (step ST25); the terminal N51 instructs the server N101 to retransmit missing content (step ST26); and the server N101 retransmits the missing content to the terminal N51 (step ST27). Likewise, the server N101 performs delivery confirmation on the terminal N52 (step ST28); the terminal N52 instructs the server N101 to retransmit missing content (step ST29); and the server N101 retransmits the missing content to the terminal N52 (not shown). Although not shown, the server N101 performs the same process with the terminal N53. In the individual retransmission process, only an inquiry for missing frames may be made, and combined information of their missing frames may be multicasting-delivered again.

Next, the case where an interruption (a path failure) occurs during relay redelivery from the terminal N51 to the terminal N52 is shown in FIG. 9 and the lower part of FIG. 10. The method of determining whether a path failure has occurred is, for example, to check whether there is no response to delivery confirmation, but the present invention is not limited to this.

The server N101 searches for the terminal N52 based on the fact that delivery confirmation is not obtained or an incompletion notification. In FIG. 10, the server N101 performs delivery confirmation on the terminal N52 (step ST30), and the terminal N52 instructs the server N101 to retransmit missing content (step ST31). If the server N101 fails to receive the instruction to retransmit missing content from the terminal N52 because of the occurrence of a link disconnection (step ST32), the server N101 searches for the terminal N52 through the terminals N51, N53 (step ST33).

In FIGS. 9 and 10, the terminal N51 responds that it can relay. The terminal N51 searches for the terminal N52 (step ST34); the terminal N52 gives a response to the terminal N51 (step ST35); and the terminal N51 notifies the server N101 of a path to the terminal N52 (step ST36). Then, the server N101 notifies the terminal N51 of an instruction to put the terminal N52 under the control for management (step ST37). The terminal N51 notifies the same to the terminal N52.

Then, the server N101 performs delivery confirmation on the terminal N53 (step ST38); the terminal N53 instructs the server N101 to retransmit missing content (step ST39); and the server N101 retransmits the missing content to the terminal N53 (step ST40). After the completion of delivery to all the adjacent terminals, the server N101 instructs the terminal N51 having the terminal N52 under its control to relay-multicasting deliver (step ST41).

The terminal N51 multicasting-delivers content and schedule directly to the terminal N52 and terminals not shown (step ST42). Because the communication environment differs, the incorrect frame is different between the terminal N52 and the not-shown terminals (steps ST43, ST44). After the completion of content delivery to all the adjacent terminals, the terminal N51 performs delivery confirmation sequentially on the terminal N52 and the not-shown terminals. If missing frames exist, the terminal N51 performs retransmission individually to them, thereby completing delivery to all the adjacent terminals.

Specifically, the terminal N51 performs delivery confirmation on the terminal N51 (step ST45); the terminal N52 instructs the terminal N51 to retransmit missing content (step ST46); and the terminal N51 retransmits the missing content to the terminal N52 (step ST47). Further, the terminal N51 performs the same process with the not-shown terminals. Then, after retransmission of the missing content finishes, the terminal N51 notifies the server N101 of the completion of multicasting delivery (step ST48). As in Embodiment 1, in the individual retransmission process, only an inquiry for missing frames may be made, and combined information of their missing frames may be multicasting-delivered again.

Although with FIGS. 8 to 10 description has been made with the server N101 as a nucleus, the terminal N12 relay-delivering and the terminals N7, N13 and so on relaying in FIG. 7 also operate likewise to deliver according to a transmission instruction from the server N101 and, if a failure in the link with a terminal that should be under its control is detected, to give the delivery result to the server N101 and thus to relay-deliver missing content out of content and schedule information held in their storage via a new path.

Here, when comparing the numbers of links involved in content delivery in the content delivery systems according to the conventional art and according to the present embodiment, there are 48 links for the conventional art (FIG. 2), whereas the number of links is reduced to six times of multicasting delivery by omitting redundant paths for the present embodiment (FIG. 7). Thus, as shown in the following equation (4), the delivery time can be reduced to about 24 minutes (about one fifth of that of the conventional art), which can be expected to lead to energy saving as well as efficient use of radio resources. Note that as to redundancy for multicasting delivery, calculation is made assuming overhead of 50% to occur because of the presence of the over-multi-frame error correction and control for individual retransmissions.

6 (links)×1.5 (redundancy)×100 (Mbytes)×8 (bits)÷5 (Mbps)÷3,600 (sec)≈0.4 (hour)=24 minutes (4)

As described above, according to the present embodiment, in the content delivery system which performs a push type of multi-hop communication by radio, a delivery server and a digital signage terminal multicasting-deliver content and the like to digital signage terminals within a range where they can simultaneously transmit and receive by radio communication. By this means, redundant links involved in content delivery can be further reduced in number, thus realizing high efficient delivery as compared with Embodiment 1.

### Embodiment 3

In this embodiment, multiple terminals perform delivery processes at the same time. The differences from Embodiments 1, 2 will be described.

In Embodiments 1, 2, the server N101 manages terminals which perform delivery by radio communication such that one terminal delivers at a time, thus preventing interference by radio. However, if the space is known beforehand to be broad enough that radio waves do not interfere in the respective areas of, e.g., terminals N7 and N18 in FIG. 3, two or more terminals may perform delivery processes in parallel at the same time.

The server N101 finds out the amount of interference between the terminals in the network as well as managing network topology according to a routing protocol in advance of information delivery of content and schedule. When calculating the amount of interference, the server N101 may automatically generate a test signal or allow a user to enter manually. Further, the server N101 may perform calculation of received power using map information, or so on.

In FIG. 3, if it is realized that the terminals N7 and N18 can simultaneously transmit/receive data without an adverse influence, the server N101 performs a process to delay transmission to the terminal N7 until transmission to the terminal N18 as well as delivering in an ascending order of from an adjacent one with a smallest number of hops.

As described above, according to the present embodiment, in the content delivery system which performs a push type of multi-hop communication by radio, if it is known beforehand that radio waves do not interfere in the respective areas of terminals, two or more terminals perform delivery processes in parallel at the same time. This means can be expected to lead to further energy saving as well as further efficient use of radio resources as compared with Embodiments 1, 2.

### Embodiment 4

In this embodiment, retransmission of missing content is performed depending on whether or not a relay delivery process is performed. The differences from Embodiment 2 will be described.

In Embodiment 2, at the time of relay redelivery, one terminal delivering finds out missing frames in terminals under the control of and managed by the one terminal and performs a redelivery process, and after the delivery process of all the content finish, one terminal delivering at the next stage performs the same process. Specifically, in FIG. 3, after finishing deliver to terminals N6, N11, N12, N16, the server N101 instructs the terminal N12 to deliver to terminals N7, N8, N13, N17 under its control. The server N101 waits for a notification from the terminal N12 that delivery to all the terminals has finished, and then instructs the terminal N7 to deliver to terminals N1, N2, N3 under its control.

In the present embodiment, the server N101 or the terminals relay-redelivering, dissolve missing content for terminals having at least one terminal under their control and relaying, but delay dissolving missing content for terminals not relaying. For example, in a case where the server N101 delivers, the terminals not relaying are terminals N6, N11, N16, and so on. Since there is a possibility that the terminals N6, N11, N16 can receive radio signals from the terminals N7, N12 relaying, they can utilize radio signals from the terminals N7, N12 for missing content.

After the server N101 and the terminals N12, N7, N13, N9, N18 perform multicasting delivery in turn, the server N101 performs delivery confirmation and the recovery of missing content individually on the terminals N6, N11, N16. Then, the server N101 has the terminal N12 perform delivery confirmation and the recovery of missing content individually on the terminals N8, N17.

As described above, according to the present embodiment, the server N101 or the terminals relay-redelivering, dissolve missing content for terminals having at least one terminal under their control and relaying, but delay dissolving missing content for terminals not relaying. This means leads to further reducing overhead associated with content delivery and can be expected to lead to energy saving as well as efficient use of radio resources.

### Embodiment 5

In Embodiments 1 to 4, description has been made of the case where common information is delivered to all the terminals. In the present embodiment, description will be made of the case where content necessary intrinsically for a particular terminal, content necessary intrinsically for multiple terminals categorized or grouped, or the like is delivered. The differences from Embodiments 1 to 4 will be described.

For example, in FIG. 3, letting Ck(N(k)) be one of contents necessary for terminal Nk and C[Nk] be all the contents necessary (Ck(N(k)) ε C[Nk]), the contents necessary for terminal N1 are expressed as C[N1]{≡C1(1), C1(2), C1(3), . . . C1(1(k))}; the contents necessary for terminal N2 are C[N2]≡{C2(1), C2(2), C2 (3), . . . C2(2(k))}; and so on. In practice, it may happen that C1(1)=C2(1) as a content common to terminals N1, N2.

Further, letting C[Nk]<all the contents> denote all the contents possessed by terminal Nk, since terminal N7 has a relay function, the contents which terminal N7 possesses are the sum of the contents necessary for terminals N1, N2, N3, N7, that is, C[N7]<all the contents>=C[N1]∪ C[N2]∪ C[N3]∪ C[N7]. As such, the sum of the contents is possessed on the near-headstream side of the formed network, but by performing control where content to be delivered is reduced as going downstream, the effect of shortening the delivery time is obtained.

Content and the like is relay-delivered to the terminal N7 from the terminal N12, but if a link failure occurs because radio communication characteristics vary with each link due to fading or the like or an obstacle gets in between terminals, the terminal N7 receives deliver of content from the terminal N6 or N11 or so on as an alternative path in its neighborhood. Hence, the terminals N6 and N11 hold as much content for terminals not under their control which they can receive as possible. Specifically, if the terminal N7 changes the path from the terminal N12 to the terminal N11, with content to be held in the terminal Nil being C[N11]<all the contents>=C[N1]∪ C[N2]∪ C[N3]∪ C[N7] ∪ C[N11], the server N101 delivers the difference from what it was before the path change.

As described above, according to the present embodiment, when content necessary is different for each terminal, terminals relay-delivering possess the sum of the contents necessary for the terminals to deliver to. This means can be expected to reduce the time required for delivering content throughout the system by the effect of reducing the delivery time for unnecessary content and lead to energy saving as well as efficient use of radio resources.

According to the present invention, the effect of being able to deliver content highly efficiently to a large number of digital signage terminals is produced.

What is claimed is:

1. A delivery server in a content delivery system which comprises the delivery server and multiple terminal devices, the delivery server delivering content, the multiple terminal devices receiving delivery of the content, in the content delivery system connection between the delivery server and the terminal devices and connection between the terminal devices being made by radio, in the content delivery system the terminal devices being connected in multiple stages,
wherein the delivery server instructs a terminal device which has received delivery of the content and which is connected to an other terminal device at the next stage to deliver content possessed by a self terminal device to the other terminal device.

2. The delivery server according to claim 1, wherein
when the delivery to the other terminal device at the next stage is interrupted and the instructed terminal device has reported, as the delivery result, interruption of delivery and an interruption location to the delivery server, the delivery server searches for a new communication path based on the report and instructs a terminal device which is on the new communication path and which is connected to the other terminal device at the next stage to deliver content subsequent to the interruption location out of content possessed by a self terminal device to the other terminal device.

3. The delivery server according to claim 1, wherein
when the delivery to the other terminal device at the next stage is interrupted and the instructed terminal device has reported, as the delivery result, interruption of delivery and an interruption location to the delivery server, the delivery server holds an alternative communication path and, based on the report, instructs a terminal device which is on a new communication path that is the alternative communication path and which is connected to the other terminal device at the next stage to deliver content subsequent to the interruption location out of content possessed by a self terminal device to the other terminal device.

4. The delivery server according to claim 1, wherein
the delivery server creates radio connection relations between itself and the terminal devices and between the terminal devices using at least one of a positional relation between itself and the terminal devices and a radio communication environment relation between itself and the terminal devices.

5. The delivery server according to claim 4, wherein
the delivery server, using at least one of the positional relation and the radio communication environment relation, instructs two or more terminal devices to deliver content possessed by a self terminal device at the same time.

6. The delivery server according to claim 1, wherein
the delivery server gives priority to terminal devices which deliver content to an other terminal device at the next stage in regard to an order of delivering content to the terminal devices.

7. A delivery server in a content delivery system which comprises the delivery server and multiple terminal devices, the delivery server delivering content, the multiple terminal devices receiving delivery of the content, in the content delivery system connection between the delivery server and the terminal devices and connection between the terminal devices being made by radio, in the content delivery system the terminal devices being connected in multiple stages,
wherein when the delivery server and the terminal devices can multicasting-communicate the content, the delivery server instructs a terminal device which has received multicasting delivery of the content and which is connected to an other terminal device at the next stage to multicasting-deliver content possessed by a self terminal device to the other terminal device.

8. The delivery server according to claim 7, wherein
after delivering the content by multicasting communication, the delivery server performs delivery confirmation of the content and, if some content is missing in a terminal device subject to the delivery confirmation, redelivers the missing content to the terminal device subject to the delivery confirmation.

9. The delivery server according to claim 7, wherein
when the delivery server and the terminal devices perform delivery confirmation of the content after delivering the content by multicasting communication, if there is no response or it has received a report that there is no response from any of the terminal devices, the delivery server searches for a new communication path and instructs a terminal device which is on the new communication path and which is connected to the terminal device subject to the delivery confirmation at the next stage to multicasting-deliver content possessed by a self terminal device to the terminal device subject to the delivery confirmation.

10. The delivery server according to claim 7, wherein
the delivery server creates radio connection relations between itself and the terminal devices and between the terminal devices using at least one of a positional relation between itself and the terminal devices and a radio communication environment relation between itself and the terminal devices.

11. The delivery server according to claim 10, wherein
the delivery server, using at least one of the positional relation and the radio communication environment relation, instructs two or more terminal devices to deliver content possessed by a self terminal device at the same time.

12. The delivery server according to claim 7, wherein
the delivery server gives priority to terminal devices which deliver content to an other terminal device at the next stage in regard to an order of delivering content to the terminal devices.

13. A terminal device in a content delivery system which comprises a delivery server and multiple terminal devices, the delivery server delivering content, the multiple terminal devices receiving delivery of the content, in the content delivery system connection between the delivery server and the terminal devices and connection between the terminal devices being made by radio, in the content delivery system the terminal devices are connected in multiple stages,
wherein when the delivery server has instructed a terminal device which has received delivery of the content and which is connected to an other terminal device at the next stage to deliver content possessed by a self terminal device to the other terminal device, the instructed terminal device delivers content possessed by the self terminal device to the other terminal device and notifies the delivery result to the delivery server.

14. The terminal device according to claim 13, wherein
if the delivery to the other terminal device at the next stage is interrupted, the instructed terminal device reports, as the delivery result, interruption of delivery and an interruption location to the delivery server,
wherein the delivery server searches for a new communication path based on the report, and when the delivery server has instructed a terminal device which is on the new communication path and which is connected to the other terminal device at the next stage to deliver content subsequent to the interruption location out of content possessed by a self terminal device to the other terminal device, the terminal device which is on the new communication path delivers the content subsequent to the interruption location out of content possessed by the self terminal device to the other terminal device at the next stage.

15. The terminal device according to claim 13, wherein
if the delivery to the other terminal device at the next stage is interrupted, the instructed terminal device reports, as the delivery result, interruption of delivery and an interruption location to the delivery server,
wherein the delivery server holds an alternative communication path, and when the delivery server, based on the report, has instructed a terminal device which is on a new communication path that is the alternative communication path and which is connected to the other terminal device at the next stage to deliver content subsequent to the interruption location out of content possessed by a self terminal device to the other terminal device, the terminal device which is on the new communication path delivers the content subsequent to the interruption location out of content possessed by the self terminal device to the other terminal device at the next stage.

16. The terminal device according to claim 13, wherein
if contents necessary for the multiple terminal devices are different, a terminal device connected to an other terminal device at the next stage possesses contents necessary for the terminal device and the other terminal device.

17. A terminal device in a content delivery system which comprises a delivery server and multiple terminal devices, the delivery server delivering content, the multiple terminal devices receiving delivery of the content, in the content delivery system connection between the delivery server and the terminal devices and connection between the terminal devices being made by radio, in the content delivery system the terminal devices are connected in multiple stages,
wherein when the delivery server and the terminal devices can multicasting-communicate the content, the delivery server has instructed a terminal device which has received multicasting delivery of the content and which is connected to an other terminal device at the next stage to multicasting-deliver content possessed by a self terminal device to the other terminal device, the instructed terminal device multicasting-delivers content possessed by the self terminal device to the other terminal devices and notifies the delivery result to the delivery server.

18. The terminal device according to claim 17, wherein
after delivering the content by multicasting communication, the terminal device performs delivery confirmation of the content and, if some content is missing in a terminal device subject to the delivery confirmation, redelivers the missing content to the terminal device subject to the delivery confirmation.

19. The terminal device according to claim 17, wherein when the delivery server and the terminal device have performed delivery confirmation of the content after delivering the content by multicasting communication, if there is no response, the terminal device reports to the delivery server,
wherein, if there is no response or it has received a report that there is no response from the terminal device, the delivery server searches for a new communication path, and when the delivery server has instructed a terminal device which is on the new communication path and which is connected to the terminal device subject to the delivery confirmation at the next stage to multicasting-deliver content possessed by a self terminal device to the terminal device subject to the delivery confirmation, the terminal device which is on the new communication path multicasting-delivers content possessed by the self terminal device to the terminal device subject to the delivery confirmation.

20. The terminal device according to claim 17, wherein
the terminal device receives the multicasting-delivered content from the delivery server and one or more terminal devices at the preceding stages or from two or more terminal devices at the preceding stages.

21. The terminal device according to claim 17, wherein
if contents necessary for the multiple terminal devices are different, a terminal device connected to an other terminal device at the next stage possesses contents necessary for the terminal device and the other terminal device.
